(19) United States
(12) Patent Application Publication
(10) Pub. No.: US 2013/0040059 A1
(43) Pub. Date: Feb. 14, 2013

(54) ANTI MICROBIAL COMPOUNDS AND THEIR USE

(71) Applicant: Mahmoud Hossein, Waalwijk (NL)

(72) Inventor: Mahmoud Hossein, Waalwijk (NL)

(73) Assignee: AM COATINGS B.V., Waalwijk (NL)

(21) Appl. No.: 13/510,759

(22) PCT Filed: Nov. 19, 2010
(86) PCT No.: PCT/EP2010/007030

§ 371 Date: Jul. 30, 2012

(30) Foreign Application Priority Data
Nov. 19, 2009 (EP) 09014447.8

(51) Int. Cl. C08F 120/34; B05D 5/00; C08F 120/60; B05D 1/38; C09D 5/14; C08L 33/16

(52) U.S. Cl. 427/385.5; 106/18.32; 524/551; 560/196; 564/153

(57) ABSTRACT

Compounds having building blocks according to the general formulae as shown in FIG. 1., wherein [BB1] is building block 1; [BB2] is building block 2; R₁ is H or CH₃, Z is a bridging group and is an ester group (—C(═O)O—) or an amide group (—C(═O)—NH—), X is an element selected from nitrogen, phosphorus, oxygen and sulfur; i is an integer which is 2 in case of nitrogen and phosphorus and 1 in case of oxygen and sulfur; Rⱼ denotes groups which may be the same or different and have a C₁-C₂₀ hydrocarbyl group; Rₖ is a C₇-C₅₀ hydrocarbyl group; Y⁻ is a negatively charged ion; and wherein the molar fraction of [BB2] in a molecule of the compound is between 0.3 and 1 and the weight average molecular weight of the compound is between 1.000 and 100.000 g/mol, determined with GPC. Compositions comprising such compounds and the use of such compounds as surfactants in a method for coating objects and in a method for preparing a latex composition.

### TECHNICAL FIELD

The invention relates to anti microbial compounds, their use in applications like coatings, in coating systems as primers and their use in methods for preparing latexes.

### BACKGROUND

Anti microbial compounds and their use are known in the art. For example WO02/10242, discloses a polyurethane dispersion comprising an anti-microbial compound and a method of making thereof. The disclosed dispersion is stable in an alcohol-water mixture and is a reaction product of (a) an isocyanate functional pre-polymer comprising the reaction product of: i) at least one oligomeric polyactive hydrogen compound, wherein said compound is an alkyl, aryl, or aralkyl structure optionally substituted in and/or on the chain by N, O, S and combinations thereof, and wherein the compound is insoluble in 50:50 weight percent of said alcohol-water mixture; ii) at least one polyisocyanate; and iii) at least one polyactive hydrogen compound soluble in the alcohol-water mixture selected from the group consisting of a compound containing an ionic group, a compound containing a moiety capable of forming an ionic group, a compound containing a polyester, polyether, or polycarbonate group having a ratio of 5 or less carbon atoms for each oxygen atom, and mixtures thereof; and (b) at least one polyfunctional chain extender.

A disadvantage of polyurethane dispersions comprising an anti-microbial compound known from WO02/10242 is that once a coating has been applied to a surface of an object, the anti-microbial is poorly immobilized in the coating especially at the surface of the coating, which may result in easy release of the anti-microbial compound from the coated surface, in particular when such surfaces are frequently cleaned with organic solvents or even with water, optionally including surfactants.

Another disadvantage of the polyurethane dispersions known from the prior art is that a stable dispersion requires the use of substantial amounts of organic solvents during the manufacture of the dispersions, which solvents remain present as a substantial ingredient in the final product.

Yet another disadvantage of polyurethane dispersions comprising an anti-microbial compound known from WO02/10242 is that the anti-microbial compound is ionically bonded to a free carboxylic acid group of the polyurethane in the polyurethane dispersion. The application of the polymeric antimicrobial compound is therefore limited to polyurethane dispersions.

It is an object of the present invention to provide an anti-microbial compound that omits or at least mitigates at least part of the above mentioned drawbacks.

It is another object of the present invention, to provide antimicrobial compounds that can be used in combination with a wide variety of (polymeric) binders, and thus not limited to polyurethane dispersions comprising such antimicrobial compounds.

### SUMMARY OF THE INVENTION

At least one of these objects is achieved by providing compounds comprising building blocks according to the following formulae:

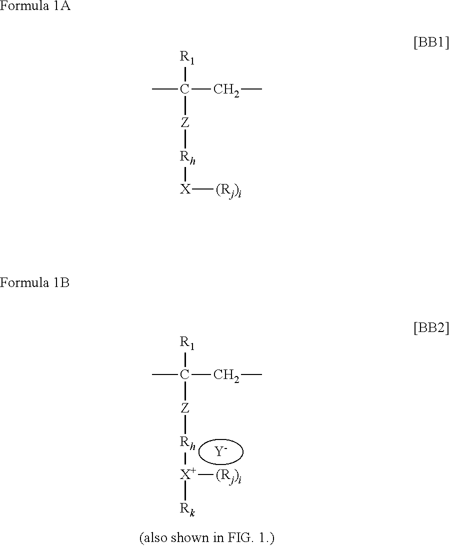

wherein:

[BB1] is building block 1;

[BB2] is building block 2;

R₁ is H or CH₃,

Z is a bridging group, selected from the group consisting of ester groups (—C(═O)O—) and amide groups (—C(═O)—NH—).

X is an element selected from nitrogen, phosphorus, oxygen and sulfur;

i is an integer which is 2 in case of nitrogen and phosphorus and 1 in case of oxygen and sulfur;

Rⱼ denotes groups which may be the same or different and comprise a C₁-C₂₀ hydrocarbyl group;

Rₖ is a C₇-C₅₀ hydrocarbyl group;

Y⁻ is a negatively charged ion;

and wherein the molar fraction of [BB2] in a molecule of the compound is between 0.3 and 1 and the weight average molecular weight of the compound is between 1.000 and 100.000 g/mol.

The polymeric antimicrobial compounds according to the present invention, are preferably used in a primer composition, which further comprises a solvent, and as a surfactant in an emulsion polymerization process.

### DETAILED DESCRIPTION

Materials

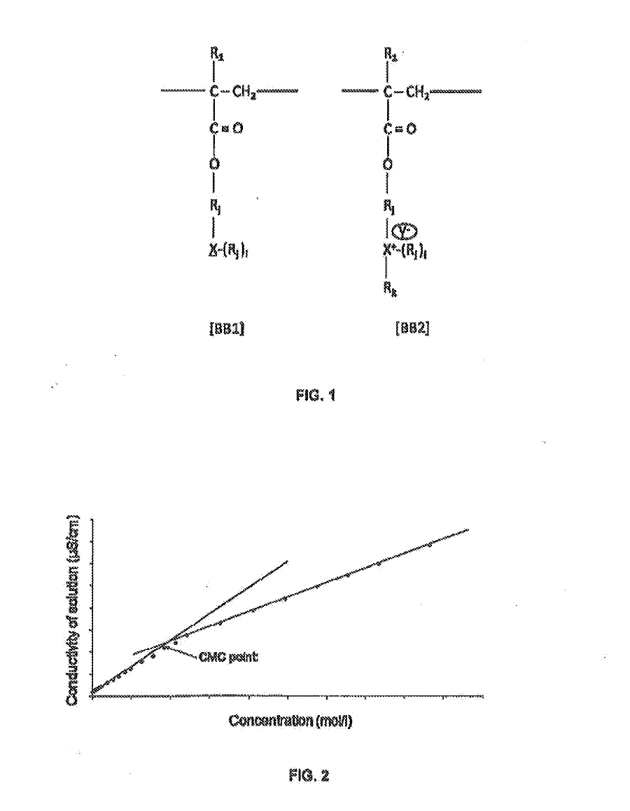

Thus the invention relates to a compound comprising building blocks according to the general formulae shown in FIG. 1, wherein:

[BB1] is building block 1;

[BB2] is building block 2;

R₁ is H or CH₃,

Z is a bridging group, selected from the group consisting of ester groups (—C(═O)O—) and amide groups (—C(═O)—NH—). X is an element selected from nitrogen, phosphorus, oxygen and sulfur;

i is an integer which is 2 in case of nitrogen and phosphorus and 1 in case of oxygen and sulfur;

Rⱼ denotes groups which may be the same or different and comprise a C₁-C₂₀ hydrocarbyl group;

Rₖ is a C₇-C₅₀ hydrocarbyl group;

Y⁻ is a negatively charged ion;

and wherein the molar fraction of [BB2] in a molecule of the compound is between 0.3 and 1 and the weight average molecular weight of the compound is between 1.000 and 100.000 g/mol.

Preferably, the Rⱼ groups comprise C₂-C₁₀ groups. The Rⱼ-groups may be the same or different.

In a first embodiment, the bridging group Z comprises an ester group. The compounds according to the present invention then comprise building blocks according to the following formulae:

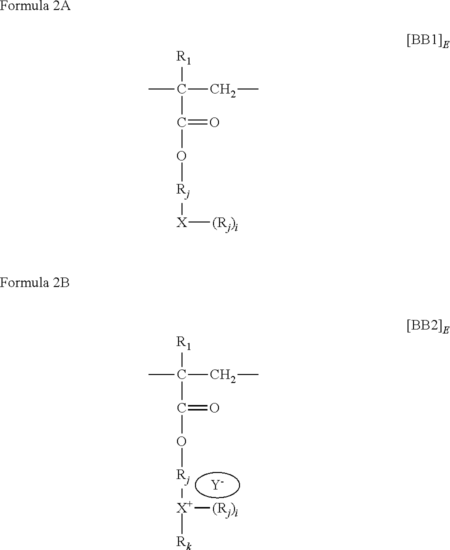

wherein:

[BB1]_{E} is building block 1;

[BB2]_{E} is building block 2;

R₁ is H or CH₃,

X is an element selected from nitrogen, phosphorus, oxygen and sulfur;

i is an integer which is 2 in case of nitrogen and phosphorus and 1 in case of oxygen and sulfur;

Rⱼ denotes groups which may be the same or different and comprise a C₁-C₂₀ hydrocarbyl group;

Rₖ is a C₇-C₅₀ hydrocarbyl group;

Y⁻ is a negatively charged ion;

and wherein the molar fraction of [BB2]_{E} in a molecule of the compound is between 0.3 and 1 and the weight average molecular weight of the compound is between 1.000 and 100.000 g/mol.

In a second embodiment, the bridging group Z comprises an amide group. The compounds according to the present invention then comprise building blocks according to the following formulae:

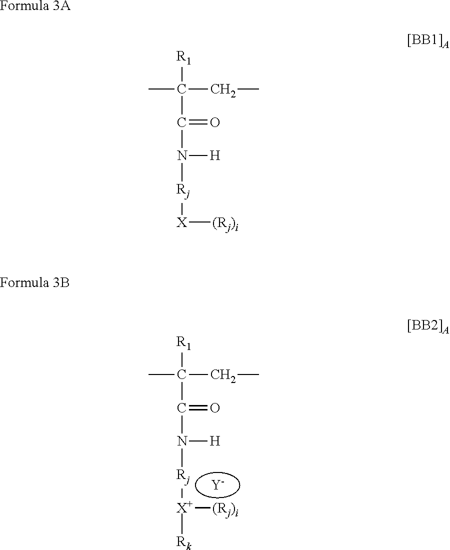

wherein:

[BB1]_{A} is building block 1;

[BB2]_{B} is building block 2;

R₁ is H or CH₃,

X is an element selected from nitrogen, phosphorus, oxygen and sulfur;

i is an integer which is 2 in case of nitrogen and phosphorus and 1 in case of oxygen and sulfur;

Rⱼ denotes groups which may be the same or different and comprise a C₁-C₂₀ hydrocarbyl group;

Rₖ is a C₇-C₅₀ hydrocarbyl group;

Y⁻ is a negatively charged ion;

and wherein the molar fraction of [BB2]_{A} in a molecule of the compound is between 0.3 and 1 and the weight average molecular weight of the compound is between 1.000 and 100.000 g/mol.

Compounds according to the present invention (comprising the building blocks as shown in Formulae 1A-1B, 2A-2B and 3A-3B, respectively) comprise derivatives of acrylates (R₁ is H) or methacrylates (i.e. R₁ is CH₃) and contain a moiety that provides amphiphilic character to the compound and anti-microbial functionality (i.e. —Rⱼ—X⁺(Rⱼ)ᵢ—Rₖ). Hereinafter, descriptions referring to [BB1] are understood as also referring to [BB1]_{E} and [BB1]_{A}. Similarly, descriptions referring to [BB2] are understood as also referring to [BB2]_{E} and [BB2]_{A}.

In order to achieve at least one of the above specified objectives of the present invention, compounds according to the present invention comprise polymers having a weight average molecular weight of at least 1.000 g/mol to prevent bleeding of the anti-microbial out of a dried and/or cured coating layer comprising such anti-microbial compound and a polymeric binder. The polymeric anti-microbial compound may be immobilized in a an applied coating layer by entanglements between the polymeric anti-microbial compound and the molecules of a polymeric binder, thus preventing bleeding even when a coated object or surface is rinsed or cleaned with a solvent. On the other hand, for the purposes of providing an anti-microbial functionality to a coated surface, the anti-microbial compound is required to have a certain mobility in a wet coating layer (i.e. a coating layer just after being applied and before drying and curing) to be able to migrate towards the interface of the coating layer with air. Therefore the weight average molecular weight is preferably not higher than 100.000 g/mol. For the compound to be able to (spontaneously) migrate to the surface, it is also preferred that the compound has surface active properties. Therefore the fraction of [BB2] in a molecule of the compound according to the present invention preferably ranges between 0.3 and 1 and the hydrocarbyl group Rₖ comprises at least 7 carbon atoms. Compounds comprising building blocks as shown in FIG. 1 and a fraction of [BB2] of below 0.3 and/or hydrocarbyl groups Rₖ comprising more than 50 carbon atoms will poorly dissolve in a polar solvent, in particular water, and are less suitable for the purposes of the present invention.

Advantages of compounds according to the present invention is that they are soluble in a wide variety of solvents, in particular polar solvents, such as water, ethanol, IPA (iso-propylalcohol) and the like, which enables the use of the anti-microbial compounds in combination with a wide variety of (polymeric) binders. Preferably water is used as a solvent in these applications.

Without wanting to be bound to any theory, the inventor believes that the anti-microbial compound at least partly migrates to the coating-air interface and that the molecules of the anti-microbial compound may be immobilized, once a coating comprising such compound has been applied, dried and/or cured. A thus coated surface will more or less have excellent permanent anti-microbial properties.

Another advantage of compounds according to the present invention is that due to the amphiphilic character they act as surface active agents.

Preferably, Rₖ in the compounds according to the present invention preferably comprises a C₁₀-C₂₅ hydrocarbyl group, more preferably a C₁₁-C₂₀ hydrocarbyl group, more preferably a C₁₂-C₁₆ hydrocarbyl group and even more preferably a linear C₁₄-alkyl group. The advantages of such a group are that it has excellent anti-microbial properties and that it provides an optimal amphiphilic character of the compound. The latter enables the compound of being soluble in many solvents, in particular in water. The compound according to this embodiment shows good surface active properties.

Preferably, the molar fraction of [BB2] in a molecule of the compound according to the present invention is between 0.50 and 0.99, preferably between 0.7 and 0.98, more preferably between 0.90 and 0.97. An advantage of a high molar fraction of [BB2] (i.e. close to 1) is that the solubility in polar solvents, in particular water is high, so that high concentrations of the polymeric antimicrobial compound can be obtained.

Another advantage of a high molar fraction of [BB2] is that the polymeric anti-microbial compound has improved surface active properties.

In one embodiment, a compound according to the present invention comprises dimethylamino-ethylmethacrylate as [BB1]_{E} and bromo-(tetradecane-dimethylamino-ethylmethacrylate) as [BB2]_{E}. The molar fraction of [BB2]_{E} in a molecule of the compound is between 0.90 and 0.97 and the weight average molecular weight ranges between 7.500 and 35.000 g/mol, determined with GPC.

In another embodiment, a compound according to the present invention comprises dimethylamino-propyl methacryl amide as [BB1]_{A} and bromo-(tetradecane-dimethylamino-propyl methacryl amide) as [BB2]_{A}. The molar fraction of [BB2]_{A} in a molecule of the compound is between 0.90 and 1.0 and the weight average molecular weight ranges between 10.000 and 50.000 g/mol, determined with GPC.

Preferably, the negatively charged ion Y⁻ in the compound according to the present invention is an anion selected from the group consisting of nitrate, sulfate, phosphate and halides (e.g. chloride, bromide, iodide and fluoride). More preferably the negatively charged ion Y⁻ is selected from the group consisting of chloride, bromide and iodide.

An advantage of such anions is that they positively contribute to the solubility of the polymeric anti-microbial compounds according to the present invention.

The present invention further pertains to compositions comprising a compound according to the present invention and a solvent. The solvent preferably is a polar solvent, in particular water.

### Applications

The present invention also relates to the use of compounds according to the present invention in a primer composition. The primer composition comprises a compound according to the present invention having a weight average molecular weight (M_{w}) in a range between 1.000 and 100.000 g/mol and a polar solvent, such as water, ethanol or IPA. For environmental reasons, preferably water is used as a solvent.

The weight average molecular weight of the compound is preferably in a range between 2.000 and 10.000 g/mol, more preferably between 3.000 and 6.000 g/mol, for example 5000 g/mol.

In this application of an anti-microbial compound according to the present invention it is advantageous to use a compound according to the present invention with a weight average molecular weight (M_{w}) according to a preferred range as stated above. A compound having a relatively low M_{w} has the tendency to bleed from a final dried and/or cured coating layer, especially when a thus coated surface is rinsed or cleaned with a solvent. A compound having a relatively high M_{w} may limit the migration speed of the compound towards the coating-air interface, which may lead to unsatisfactory low anti-microbial functionality at the coating-air interface. A larger amount of anti-microbial compound is then required to obtain satisfactory anti-microbial functionality. This implies that the required layer thickness of the first layer of a composition according to the present invention (primer) increases with increasing M_{w} of the compound.

The M_{w} of the compound according to the present invention may be optimized in order to find a balance between the above described properties (i.e. migration speed, tendency to bleeding, required amount of anti-microbial compound, required layer thickness of the primer).

In this application of an anti-microbial compound according to the present invention, the molecular weight distribution, expressed as the ratio between the weight average molecular weight and the number averaged molecular weight (Mw/Mn, i.e. the polydispersity index (PDI)) may be in a range between 1 and 10, preferably between 1.5 and 5, more preferably between 1.9 and 3.

In this application of an anti-microbial compound according to the present invention, the fraction of [BB2] in a molecule of the compound according to the present invention is in a range from 0.50 to 1, preferably between 0.8 and 0.99.

It is noted here, that other anti-microbial compounds may be suitable for use in this application, in particular an anti-microbial compound selected from the group comprising:

N-alkylated polyethylenimine (N-alkylated-PEI), Poly(4-vinyl-N-alkylpyridinium bromide), N-hexylated poly(4-vinylpyridine (Hexyl-PVP), polystyrene block-poly(4-vinyl-N-methylpyridinium iodide) (P4VMP)[(PS-b-P4VMP), poly[tributyl(4-vinylbenzyl)phosphonium chloride (PTBVBP), poly(arylenesulfonium) salts. In an embodiment the primer composition may be used in a method for applying an anti-microbial coating on a substrate comprising the steps of:
providing a substrate;
applying a first layer of the primer composition according to the present invention onto the substrate;
drying;
applying a second layer of a coating composition onto the thus obtained substrate.

The first layer may be applied by any known coating technique suitable for coating the objects to be coated, for example spray-coating, brushing, rod-coating and the like. The layer thickness of the first layer before drying may be in a range between 10 and 500 μm, preferably between 25 and 250 μm, more preferably between 50 and 150 μm, for example typically 100 μm.

The second layer of a coating composition may comprise a polymer dissolved in a solvent; a polymer precursor dispersed or dissolved in a solvent and cured after applying; or a (stabilized) polymer dispersion, i.e. a latex.

In an embodiment, the coating composition used in the method for coating a substrate comprises a latex composition comprising at least one polymer selected from the group comprising polystyrene, polyacrylate, polymethacrylate, natural rubber and derivatives thereof, for example polybutylmethacrylate.

The second layer of a coating composition may be applied after drying of the first layer of a composition according to the present invention. It suffices to dry the first layer until it is visually dry, which means that a person viewing the coated surface, preferably at several angles, obtains the visual impression that the coated surface is dry (e.g. decreased gloss of the coated surface). Usually it takes about 1 h for the first layer to dry.

The second layer may be applied by any known coating technique suitable for coating the objects to be coated, for example spray-coating, brushing, rod-coating and the like. The layer thickness of the first layer before drying may be in a range between 10 and 500 μm, preferably between 25 and 250 μm, more preferably between 50 and 150 μm, for example typically 100 μm.

The present invention also relates to the use of compounds according to the present invention in a composition suitable for use in a method for preparing a latex composition.

The concentration of the compound according to the present invention in such a composition, is then preferably above the critical micelle concentration (cmc).

Preferably the compound is dissolved in an amount between 1 and 100 times the cmc, more preferably between 2 and 50 times the cmc, and most preferably between 5 and 35 times the cmc. The critical micelle concentration is the concentration (in any desired unit, % wt/wt, mol/l, gr/l, etc, usually in mol/l) of a surface active agent (e.g. soap) above which micelles are formed in the solution. In the context of the present invention, the compounds according to the present invention may act as surface active agents. Micelles are aggregates of molecules of a surface active agent. The aggregates are formed such that, the aggregates comprise a polar outer shell and an apolar inner core, or vice versa, depending on the polarity of the solvent.

Compositions according to this embodiment are suitable compositions for performing an emulsion polymerization in, because the micelles may take up and stabilize monomers, which monomers are usually immiscible with water. The micelles comprising monomers can act as small reactors.

The compounds according to the present invention, stabilize the monomer-in-water emulsion. In this application of an anti-microbial compound according to the present invention it is advantageous that the compound according to the present invention has a weight average molecular weight above 10.000 g/mol, preferably between 10.000 and 90.000 g/mol. Such compounds usually show a low cmc, which implies that relatively small amounts of the compound are required to form micelles.

Again it is noted, that other anti-microbial compounds may be suitable for use in this application, in particular an anti-microbial compound selected from the group comprising:

N-alkylated polyethylenimine (N-alkylated-PEI), Poly(4-vinyl-N-alkylpyridinium bromide), N-hexylated poly(4-vinylpyridine (Hexyl-PVP), polystyrene block-poly(4-vinyl-N-methylpyridinium iodide) (P4VMP)[(PS-b-P4VMP), poly[tributyl(4-vinylbenzyl)phosphonium chloride (PTBVBP), poly(arylenesulfonium) salts.

In an embodiment, the present invention relates to a method for preparing a latex composition, the method comprising the steps of:
providing a first composition comprising a compound according to the present invention and water, wherein the concentration of the compound in the first composition is above the critical micelle concentration (cmc);
mixing the first composition with a monomer;
heating the obtained mixture to a temperature between 50° C. and 90° C.;
optionally adding an initiator;
reacting for a period between 1 and 10 hours.

By continuously stirring an emulsion of monomer droplets in water is maintained. The monomer droplets are stabilized due to the presence of a compound according to the present invention on the monomer-water interface of the monomer droplets.

A polymerization reaction may be initiated by UV-radiation, ultrasonic agitation or any other method known to the skilled man. The monomers will then polymerize.

If an initiator is added to the system, a part of the initiator molecules may be captured by monomer droplets (micelles comprising monomer and initiator). Another part may be in the water-phase and being stabilized by a compound according to the present invention (micelles comprising initiator). When the initiator is activated (thermally or by radiation), a polymerization reaction may be started in the stabilized monomer droplets or in the micelles comprising initiator. In the latter the monomer may be provided due to diffusion of the monomer through the aqueous phase. In both mentioned cases the micelles act as small reactors. For practical reasons (e.g. large scale industrial production), a thermally activated initiator is preferred. During the polymerization reaction the compounds according to the present invention stabilize the reaction mixture (i.e. monomers, formed oligomers and polymers and initiators). After the polymerization reaction the compounds according to the present invention stabilize the formed polymer particles in the latex.

Preferably the monomer used in the method for preparing a latex composition, is selected from the group consisting of styrene and butyl(meth)acrylate.

Measurement Techniques

Conversions Monitored by GC

During performing the polymerizations (i.e. preparation of a polymeric anti-microbial compounds according to the present invention), the conversion is monitored by GC. At certain intervals a sample is taken and the monomer content is analyzed. Before injection, all samples are dissolved in THF to a concentration of 20-40 mg/mL. The analyses are carried out on a HP Gas Chromatographer Model HP5890 series II gas chromatograph with a HP Ultra 2 crosslinked 5% Me-Ph-Si column (25 m×0.32 mm×0.52 μm film thickness) and fitted with a split injector and autosampler. The injection volume is 1.0 μL and helium was used as mobile phase. The detection is performed using a FID detector, which is kept at constant temperature of 250° C. The temperature profile used for the analyses is as follows:
Keep initial temperature of 40° C. for 0 minutes
Heat to 100° C. at 5° C./min
Heat to 275° C. at 25° C./min
Keep final temperature of 275 for 2 minutes
Cool down to 40° C.

The conversion at any time may be calculated according to the following formula:

$$Conversion ( t ) = ( 1 - \frac{monomer content at t = t}{monomer content at t = 0} ) * 100 \%$$

Molecular Weight Determination by GPC

GPC is used to determine the number and weight average molecular weight (Mₙ and M_{w}, respectively) and polydispersity index (PDI) of the polymers. Before injection, the polymer samples are dissolved in THF to a concentration of 1-2 mg/mL and filtered over a 13 mm×0.2 μm PTFE filter, PP housing (Altech). GPC analyses are carried out using a Waters model 510 pump, a model 410 refractive index detector (at 40° C.) and a model 486 UV detector (at 254 nm) in series. Injections are done by a Waters model WISP 712 autoinjector, using an injection volume of 50 μL. The columns used are a PLgel guard (5 μm particles) 50×7.5 mm column, followed by two PLgel mixed-C (5 μm particles) 300×7.5 mm columns at 40° C. in series. THF was used as eluent at a flow rate of 1.0 mL/min. Calibration has been done using polystyrene standards (polymer Laboratories, Mₙ=580 to 7.1×10⁶ g/mol). Data acquisition and processing are performed using Water Millenium32 (v4.0) software.

Molecular Structure by MALDI-TOF and NMR

Matrix Assisted Laser Desorption Ionization-Time of Flight-Mass spectroscopy (MALDI-TOF-MS) is carried out on a Voyager DE-STR from Applied Biosystems. The matrix trans-2-[3-(4-tert-butylphenyl)-2-methyl-2-propenylidene]malononitrile (DCTB) is synthesized according to literature procedures. Potassium trifluoroacetate (Aldrich, >99%) was added to poly(cyclohexene carbonate) PCHC as cationization agents. The matrix is dissolved in THF at a concentration of 40 mg·mL⁻¹. The potassium trifluoroacetate salt is added to THF at typical concentrations of 1 mg·mL⁻¹. Polymer is dissolved in THF at approximately 1 mg·mL⁻¹. In a typical MALDI-ToF-MS analysis the matrix, salt and polymer solution are premixed in a ratio of 10:1:5. The premixed solutions are handspotted on the target well and left to dry. Spectra are recorded in both the linear mode and reflector mode. Data analysis is done using the software DATA EXPLORER version 4.0 from Applied Biosystems. Also this software is used in combination with an in-house developed software tool.

¹H-NMR (Hydrogen Nuclear Magnetic Resonance) spectra are recorded on a Varian Gemini 300-spectrometer. Data are processed using the Hummingbird Connectivity 7.0. Samples are dissolved in CDCl₃ (100 mg/mL).

Dynamic Light Scattering (DLS).

DLS measurements are performed with a Brookhaven Instruments Corp. DLS apparatus that consists of a BI-200 goniometer, a BI-2030 digital correlator, and an Ar ion laser (LEXEL Lasers) with a wavelength of 488 nm. The scattering angle used for the measurements is 90°. A refractive index matching bath of filtered decalin surrounds the scattering cell, and the temperature is controlled at 25° C.

DLS measurements may be used for conversion measurements during emulsion polymerization.

Critical Micelle Concentration (cmc) by Conductivity Measurements

cmc-s are determined by measuring the conductivity of a surfactant solution as a function of the surfactant concentration. A plot is obtained that shows an inflection point that coincides with the critical micelle concentration (see FIG. 2). The reduced gradient above the cmc is due the fact that all of the surfactant ions added after the cmc are incorporated into micelles, therefore contributing less to an increase in the conductivity of the solution.

The invention will now be explained by the following examples and with reference to the appended FIGS. 1 and 2.

FIG. 1 shows the formulae of the building blocks [BB1] and [BB2];

FIG. 2 shows a graph in which the conductivity of a solution of a surface active compound is plotted (y-axis) against the concentration of the solution. The inflection point coincides with the critical micelle concentration of the solution.

### EXAMPLE 1

### Preparation of poly bromo-(tetradecane-dimethylamino-ethylmethacrylate)

Dimethylamino-ethylmethacrylate (DMAEMA) was dissolved in 3 times by weight with respect to the amount of DMAEMA of butyldiglycol (2,5-dimethyl-2,5-di(tert-butylperoxy)hexane). The reaction mixture was degassed with Nitrogen under stirring for at least 15 minutes. The reaction mixture was then heated to 120° C. and when this temperature was reached 3.7 wt % with respect to pDMAEMA Trigonox®101 was added as an initiator. The reaction proceeded for 2 hours, after which 1.06 times by weight with respect to the amount of pDMAEMA of 1-bromotetradecane was added. The reaction proceeded during at least 6 hours at reflux temperature about 160° C.

¹H NMR analysis before and after quaternization confirmed that 95% of the pendant amines were quaternized (i.e the molar fraction of [BB2]_{E} in the molecules was 0.95), on the basis of the_CH₂_{_{—}}N_multiplet and the_N_(CH₃)₂ multiplet of PDMAEMA at 2.6 and 2.2 ppm, respectively, which decreased to the benefit of two new signals: a singlet at 3.1 ppm for the methyl groups [_N [symbol] _(CH₃)₂] and a multiplet at 3.4 ppm for the methylene protons (_CH₂_{_{—}}N [symbol] _CH₂) of the quaternized units.

The weight average molecular weight was 75.000 g/mol. Universal calibration using Mark-Howing parameters, Alpha(0.664) and k(0.000148) values of pDMAEMA were used for homopolymers pDMAEMA.

### EXAMPLE 2

### Coating a Substrate with a Primer Comprising the Compound of Example 1 Followed by a Second Coating Comprising a Latex

The compound obtained in example 1 was dissolved in water in a concentration of 30% wt/wt. The solution was applied onto a substrate (by brushing, spraying or the like), such that a wet layer thickness of about 100 μm was obtained. After drying for approximately 1 hour, a second coating comprising a waterborne butylmethacrylate (BMA) latex was applied. During drying and curing of the coating, at least a part of the anti-microbial primer migrated towards the surface of the coating, thus providing an anti-microbial surface.

### EXAMPLE 3

### Emulsion Polymerization of Butylmethacrylate using the Compound of Example 1 as a Surfactant

A recipe for emulsion polymerization of BMA which is stabilized by synthesized polymeric surfactant poly tetradecanedimethylaminoethylmethaacrylate (pTDMAEMA) with concentration of 30× more than cmc is as follows:

8.0 grams (0.056 mol) of distilled BMA, 72.0 grams (4.0 mol) of dionized H₂O, 0.010 grams (3.51×10⁻⁷ mol) of synthesized polymeric surfactant are mixed in a emulsion reactor (100 ml). After degassing with Nitrogen for 20 min, was the mixture heated till 80° C. When the temperature of the reaction mixture was at 80° C., 0.04 grams (1.38×10⁻⁴ mol) of the initiator (VA-86) were added. The reaction mixture was reacting for 5 hours. Aliquots were taken during the reaction to follow conversion by GC and gravimetrically and Dynamic Light Scattering (DLS) analysis.

### EXAMPLE 4

### Anti-Microbial Testing

Bacteria were grown in yeast/dextrose broth (Cunliffe et al. 1999) at 37° C. with aeration at 200 rpm for 6-8 h. The inoculum from an overnight culture was transferred into 0.1 M PBS (approximately 10¹¹ cells ml⁻¹) and then introduced into the growth medium at a 1:500 dilution. The bacterial cells were centrifuged at 5160×g for 10 min and washed with distilled water twice. A bacterial suspension at a concentration of 10⁶ cells ml⁻¹ in distilled water was sprayed at a rate of approximate 10 ml min⁻¹ onto the surface of a slide in a fume hood. After drying for 2 min under air, the slide was placed in a Petri dish, and growth agar (0.7% agar in the yeast/dextrose broth, autoclaved, and cooled to 37° C.) was added. The Petri dish was sealed and incubated at 37° C. overnight. The grown bacterial colonies were counted on a light box. The waterborne bacterial suspension was prepared as follows: bacterial cells were centrifuged at 5160×g for 10 min, washed twice with PBS at pH 7, re-suspended in the same buffer, and diluted to 2×10⁶ cells ml⁻¹. A slide was immersed in 45 ml of the suspension and incubated with shaking at 200 rpm at 37° C. for 2 h, then rinsed three times with sterile PBS, and incubated in it for 1 h. The slide was immediately covered with a layer of solid growth agar (1.5% agar in the yeast/dextrose broth, autoclaved, poured into a Petri dish, and dried under reduced pressure at room temperature overnight). The bacterial colonies were then counted.

These tests were performed with two kinds of bacteria, E. coli and Staphylococcus sp. E. coli is a gram-negative bacterium and staphylococcus is a gram-positive bacterium. In Table 1 an overview is given for each coating and its antimicrobial properties.

TABLE 1
Overview of antimicrobial activity of antimicrobial coatings with
different concentration of surfactant (in wt %). The molecular weight
of all of the surfactants is 15.000 g/mol. The quaterinzation degree
of all surfactants is more than 95%.

| | | Staphylococcus | | | |
|---|---|---|---|---|---|
| | Concentration | sp. | | E. coli | |
| | surfactant | Live | Dead | Live | Dead |
| Coating | (wt %) | (%) | (%) | (%) | (%) |
| BMA SDS (Blank) | 2 | 7.04 | 92.96 | 89.02 | 10.98 |
| BMA pDMTDAEMA | 7.5 | 4.81 | 95.19 | 1.22 | 98.78 |
| BMA pDMTDAEMA | 5.0 | 4.72 | 95.28 | 1.52 | 98.48 |
| BMA pDMTDAEMA | 2.5 | 5.67 | 94.33 | 2.97 | 97.03 |
| BMA pDMTDAEMA | 2 | 6.23 | 93.77 | 3.30 | 96.70 |
| Negative control | | 0.06 | 99.94 | 1.57 | 98.43 |
| (autoclaved) | | | | | |
| Positive control (saline) | | 95.33 | 4.67 | 77.98 | 22.02 |

As can be seen from Table 1, the staphylococcal strain is easily killed on all coatings, and it can be concluded that there is no difference in antimicrobial activity between these coatings on the staphylococcal strain. The E. coli strain actually shows a higher kill rate for the positive control sample relative to the blank sample. All coatings that contain the antimicrobial block copolymer show excellent antimicrobial properties against the strain of E. coli used for these tests. The antimicrobial activity increase with increasing the concentration.

Table 2 shows the effect of the molecular weight of the anti-microbial compound. It can be concluded that the anti-microbial activity increases with increasing molecular weight.

TABLE 2
Overview of antimicrobial activity of antimicrobial coatings with
different molecular weight of surfactant. The quaterinzation degree
of all surfactants is more than 95%. The concentration of surfactant
in the emulsion polymerization is 2.5 wt %.

| | | Staphylococcus | | | |
|---|---|---|---|---|---|
| | Mw of | sp. | | E. coli | |
| | Surfactant | Live | | Live | Dead |
| Coating | (g/mol) | (%) | Dead (%) | (%) | (%) |
| BMA SDS (Blank) | 289 | 7.04 | 92.96 | 89.02 | 10.98 |
| BMA pDMTDAEMA | 35000 | 1.81 | 98.19 | 1.22 | 98.78 |
| BMA pDMTDAEMA | 20000 | 1.72 | 98.28 | 1.52 | 98.48 |
| BMA pDMTDAEMA | 15000 | 3.67 | 96.33 | 2.97 | 97.03 |
| BMA pDMTDAEMA | 7500 | 10.23 | 89.77 | 7.30 | 92.70 |
| Negative control | | 0.06 | 99.94 | 1.57 | 98.43 |
| (autoclaved) | | | | | |
| Positive control (saline) | | 95.33 | 4.67 | 77.98 | 22.02 |

### EXAMPLE 5

### Preparation of poly bromo-(tetradecane-dimethylamino-propylmethacrylamide

N-(3-(dimethylamino)propyl)methacrylamide (DMAPMAA), was dissolved in 3 times by weight with respect to the amount of DMAPMAA of butyldiglycol (2,5-dimethyl-2,5-di(tert-butylperoxy)hexane). The reaction mixture was degassed with Nitrogen under stirring for at least 15 minutes. The reaction mixture was then heated to 140° C. and when this temperature was reached 3.7 wt % with respect to DMAPMAA Trigonox®101 was added as an initiator. The reaction proceeded for 2 hours, after which 1.06 times by weight with respect to the amount of pDMAPMAA of 1-bromotetradecane was added. The reaction proceeded during at least 5 hours about 180° C.

¹H NMR analysis before and after quaternization confirmed that 95% of the pendant amines were quaternized (i.e the molar fraction of [BB2]_{A} in the molecules was 0.95), on the basis of the_CH₂_{_{—}}N_multiplet and the_N_(CH₃)₂ multiplet of PDMAPMAA at 2.8 and 2.4 ppm, respectively, which decreased to the benefit of two new signals: a singlet at 3.4 ppm for the methyl groups [_N [symbol] _(CH₃)₂] and a multiplet at 3.7 ppm for the methylene protons (_CH₂_{_{—}}N [symbol] _CH₂) of the quaternized units.

The weight average molecular weight was 47.000 g/mol. Universal calibration using Mark-Howing parameters, Alpha(0.664) and k(0.000148) values of pDMAEMA were used for homopolymers pDMAPMAA.

### EXAMPLE 6

### Coating a Substrate with a Primer Comprising the Compound of Example 4 Followed by a Second Coating Comprising a Latex

The compound obtained in example 5 was dissolved in water in a concentration of 10% wt/wt. The solution was applied onto a substrate (by brushing, spraying or the like), such that a wet layer thickness of about 100 μm was obtained. After drying for approximately 1 hour, a second coating comprising a waterborne butylmethacrylate (BMA) latex was applied. During drying and curing of the coating, at least a part of the anti-microbial primer migrated towards the surface of the coating, thus providing an anti-microbial surface.

### EXAMPLE 7

### Emulsion Polymerization of Butylmethacrylate using the Compound of Example 5 as a Surfactant

A recipe for emulsion polymerization of BMA which is stabilized by synthesized polymeric surfactant poly-bromo(tetradecane-dimethylamino-ethylmethacrylamide (pTDMAPMAA) with concentration of 50× more than cmc is as follows:

8.0 grams (0.056 mol) of distilled BMA, 72.0 grams (4.0 mol) of dionized H₂O, 0.010 grams (3.51×10⁷ mol) of synthesized polymeric surfactant are mixed in a emulsion reactor (100 ml). After degassing with Nitrogen for 20 min, was the mixture heated till 80° C. When the temperature of the reaction mixture was at 80° C., 0.04 grams (1.38×10⁻⁴ mol) of the initiator (VA-86) were added. The reaction mixture was reacting for 3 hours. Aliquots were taken during the reaction to follow conversion by GC and gravimetrically and Dynamic Light Scattering (DLS) analysis.

### EXAMPLE 8

### Anti-Microbial Testing

Anti-microbial tests were performed with the compound prepared in Example 5 according to the procedure described in Example 4. The results are shown in Table 3.

Table 3 shows that the anti-microbial effect of poly-bromo(tetradecane-dimethylamino-ethylmethacrylamide, being the surfactant, is already high (i.e. 98%) at a low concentration of the surfactant (2%).

Table 3: Overview of antimicrobial activity of antimicrobial coatings with different concentration of surfactant (in wt %). The molecular weight of all of the surfactants is 17.500 g/mol. The quaterinzation degree of all surfactants is more than 90%.

| | | Staphylococcus | | | |
|---|---|---|---|---|---|
| | Concentration | sp. | | E. coli | |
| | surfactant | Live | Dead | Live | Dead |
| Coating | (wt %) | (%) | (%) | (%) | (%) |
| BMA SDS (Blank) | 2 | 8 | 92 | 89 | 11 |
| BMA pDMTDAPMAA | 7.5 | 1 | 99 | 1 | 99 |
| BMA pDMTDAPMAA | 5.0 | 2 | 98 | 2 | 98 |
| BMA pDMTDAPMAA | 2.5 | 2 | 98 | 2 | 98 |
| BMA pDMTDAPMAA | 2 | 2 | 98 | 2 | 98 |
| Negative control | | 0.06 | 99.94 | 1.57 | 98.43 |
| (autoclaved) | | | | | |
| Positive control (saline) | | 95.33 | 4.67 | 77.98 | 22.02 |

What is claimed is:

1. A compound, comprising: building blocks according to the following general formulae: 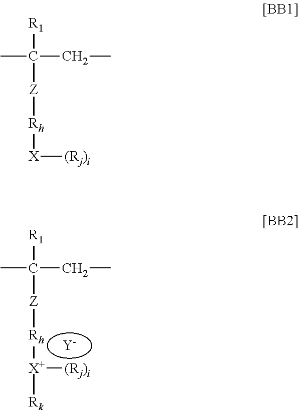
wherein:
[BB1] is building block 1;
[BB2] is building block 2;
R₁ is H or CH₃,
Z is a bridging group, and is an ester group (—C(═O)O—) or an amide group (—C(═O)—NH—),
X is an element selected from nitrogen, phosphorus, oxygen and sulfur;
i is an integer which is 2 in case of nitrogen and phosphorus and 1 in case of oxygen and sulfur;
Rⱼ denotes groups which may be the same or different and comprise a C₁-C₂₀ hydrocarbyl group;
Rₖ is a C₇-C₅₀ hydrocarbyl group;
Y⁻ is a negatively charged ion;
and wherein a molar fraction of [BB2] in a molecule of the compound is between 0.3 and 1 and a weight average molecular weight of the compound is between 1.000 and 100.000 g/mol, determined with GPC.

2. The compound according to claim 1, wherein Z is the ester group.

3. The compound according to claim 1, wherein Z is the amide group.

4. The compound according to claim 1, wherein Rₖ is a C₁₁-C₂₀ hydrocarbyl group.

5. The compound according to claim 1, wherein the molar fraction of [BB2] in a molecule of the compound is between 0.70 and 0.98.

6. The compound according to claim 1, wherein Y⁻ is chloride, bromide, or iodide.

7. The compound according to claim 1, wherein the compound has dimethylamino-ethylmethacrylate as [BB1] and bromo-(tetradecane-dimethylamino-ethylmethacrylate) as [B132], the molar fraction of [BB2] in a molecule of the compound is between 0.90 and 0.97 and the weight average molecular weight ranges between 7.500 and 35.000 g/mol, determined with GPC.

8. The compound according to claim 1, wherein the compound has dimethylamino-propyl methacryl amide as [BB1] and bromo-(tetradecane-dimethylamino-propyl methacryl amide) as [BB2], the molar fraction of [BB2] in a molecule of the compound is between 0.90 and 1.0 and the weight average molecular weight ranges between 10.000 and 50.000 g/mol, determined with GPC.

9. A composition comprising a compound according to claim 1 and a solvent.

10. A method for coating a substrate comprising the steps of:
providing a substrate;
applying a first layer of a first composition comprising a compound comprising building blocks according to the following general formulae: 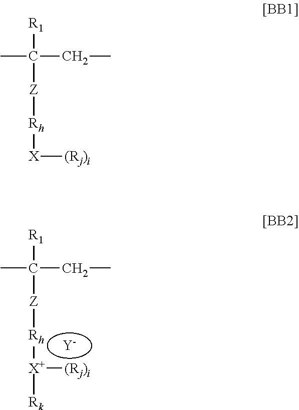
wherein: [BB1] is building block 1;
[BB2] is building block 2;
R₁ is H or CH₃,
Z is a bridging group, and is an ester group (—C(═O)O—) or an amide group (—C(═O)—NH—),
X is an element selected from nitrogen, phosphorus, oxygen and sulfur;
i is an integer which is 2 in case of nitrogen and phosphorus and 1 in case of oxygen and sulfur;
Rⱼ denotes groups which may be the same or different and comprise a C₁-C₂₀ hydrocarbyl group;
Rₖ is a C₇-C₅₀ hydrocarbyl group;
Y⁻ is a negatively charged ion;
and wherein a molar fraction of [BB2] in a molecule of the compound is between 0.3 and 1 and a weight average molecular weight of the compound is between 1.000 and 100.000 g/mol, determined with GPC, and a solvent;
drying; and
applying a second layer of a coating composition onto the thus obtained substrate.

11. The method according to claim 10, wherein the coating composition comprises a latex composition comprising at least one of the polymers comprising polystyrene, polyacrylate, polymethacrylate, natural rubber and derivatives thereof.

12. The composition according to claim 9, wherein the concentration of the compound is above a critical micelle concentration (cmc).

13. A method for preparing a latex composition, the method comprising the steps of:
providing a first composition comprising a compound building blocks according to the following general formulae: 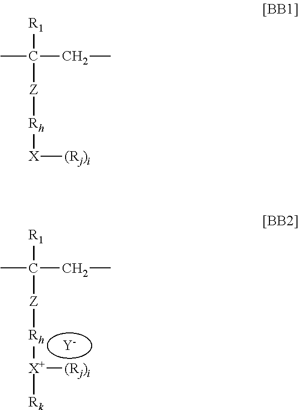
wherein:
[BB1] is building block 1;
[BB2] is building block 2;
R₁ is H or CH₃,
Z is a bridging group, and is an ester group (—C(═O)O—) or an amide group (—C(═O)—NH—),
X is an element selected from nitrogen, phosphorus, oxygen and sulfur;
i is an integer which is 2 in case of nitrogen and phosphorus and 1 in case of oxygen and sulfur;
Rⱼ denotes groups which may be the same or different and comprise a C₁-C₂₀ hydrocarbyl group;
Rₖ is a C₇-C₅₀ hydrocarbyl group;
Y⁻ is a negatively charged ion;
and wherein a molar fraction of [BB2] in a molecule of the compound is between 0.3 and 1 and a weight average molecular weight of the compound is between 1.000 and 100.000 g/mol, determined with GPC, and water, wherein the concentration of the compound in the first composition is above the critical micelle concentration (cmc);
mixing the first composition with a monomer;
heating the obtained mixture to a temperature between 50° C. and 90° C.;
adding an initiator; and
reacting for between 1 and 10 hours.

14. The method for preparing a latex composition according claim 13, wherein the monomer comprises one or more of styrene and butyl(meth)acrylate.

15. The compound according to claim 2, wherein Rₖ is a C₁₁-C₂₀ hydrocarbyl group; wherein the molar fraction of [BB2] in a molecule of the compound is between 0.70 and 0.98; and wherein Y⁻ is chloride, bromide, or iodide.

16. The compound according to claim 3, wherein Rₖ is a C₁₁-C₂₀ hydrocarbyl group; wherein the molar fraction of [BB2] in a molecule of the compound is between 0.70 and 0.98; and wherein Y⁻ is chloride, bromide, or iodide.

17. The composition according to claim 9, wherein the solvent is water.

18. The method according to claim 10, wherein Rₖ is a C₁₁-C₂₀ hydrocarbyl group; wherein the molar fraction of [BB2] in a molecule of the compound is between 0.70 and 0.98; and wherein Y⁻ is chloride, bromide, or iodide.

19. The method according to claim 10, wherein the solvent is water.

20. The method according to claim 13, wherein Rₖ is a C₁₁-C₂₀ hydrocarbyl group; wherein the molar fraction of [BB2] in a molecule of the compound is between 0.70 and 0.98; and wherein Y⁻ is chloride, bromide, or iodide.
